(19) United States
(12) Patent Application Publication
(10) Pub. No.: US 2012/0048978 A1
(43) Pub. Date: Mar. 1, 2012

(54) DRUG MILLER

(75) Inventor: Kow-Je Ling, Taipei City (TW)

(73) Assignee: HERMOSA THIN FILM CO., LTD., Taipei City (TW)

(21) Appl. No.: 12/904,153

(22) Filed: Oct. 13, 2010

(30) Foreign Application Priority Data
Aug. 31, 2010 (TW) 099129221

(51) Int. Cl. B02C 1/00

(52) U.S. Cl. 241/283

(57) ABSTRACT

A drug miller includes a first carrier, a second carrier, a base, a first motion element and a second motion element; the first motion element is coupled movably to the base; the second motion element is coupled movably to the first motion element; the base supports the first carrier; the second motion element presses the second carrier, allowing the edible first and second carriers to grind a drug into fragments; using the base, first motion element and second motion element, the drug is ground into fragments and the drug fragments are encapsulated in the edible first and second carriers more conveniently and rather not damaging the first and second carriers. Whereby, an animal rather cannot smell the odor of the drug from the outsides of the first and second carriers, and eats the drug with the drug together with the edible first and second carriers.

### BACKGROUND OF THE INVENTION

1. Field of the Invention

The present invention relates to a drug miller, and more particularly to a drug miller of edible first and second carriers capable of milling drugs for animals such as cats, dogs and etc.

2. Description of Related Art

Most dog breeders always uses a drug pestle to mill drugs into fragments and mixes the drug fragments with dog's food while feeding a dog with drugs, allowing the dog to eat the food and the drug fragments at the same time. But, the dog will use its olfactory sense to differentiate the drug segments from the food and will eat up all the food but leave the drug segments in a bowl behind.

Taiwan Patent No. M376294 discloses a multifunctional drug powder miller, comprising a medicine box, adapted to accept pills therein; a medicine box cover, adapted to prevent the pills from being dropped out; a drug powder milling rammer, connected to the medicine box and adapted to crush the drugs; a drug powder milling groove, adapted to accept the pills yet to be milled convenient for the hammering and milling of the powder milling rammer thereby milling the pills into powder; and a water cup seat, connected to the powder milling groove, and adapted to pour water therein.

Chinese Patent No. CM2524746Y discloses a compact drug crusher, constituted by a base and a pressure plate, where a raised projection structure is disposed on the lower end of the pressure plate, and a pit corresponding to the projection structure is disposed on the upper end of the base, thereby crushing drugs into drug segments or powder convenient for a user's eating.

Although the aforementioned drug millers can mill the animal drugs into segments so as to be convenient to mix them with animal food, animals, as mentioned above, can differentiate the food from drug segments, and might eat up all the food and leave the drug segments behind. Therefore, an animal medication cannot be completed smoothly.

### SUMMARY OF THE INVENTION

To improve a drug miller, allow animals to eat drug segments conveniently, the present invention is proposed.

The main object of the present invention is to provide a drug miller, utilizing edible first and second carriers with a milling function to grind drugs into fragments, and allowing the first and second carriers to encapsulate the drug fragments.

Another object of the present invention is to provide a drug miller, convenient to grind drugs into fragments, and encapsulating the drug fragments in edible first and second carriers, thereby allowing animal rather not to smell the odors of the drugs and eat the edible first and second carriers together with the drugs.

### BRIEF DESCRIPTION OF THE DRAWINGS

The present invention can be more fully understood by reference to the following description and accompanying drawings, in which:

FIG. 1 is a schematic view, showing a drug miller, a first carrier and a second carrier of a first preferred embodiment according to the present invention;

FIG. 2 is a perspective view, showing a drug miller, a first carrier and a second carrier of the first embodiment according to the present invention;

FIG. 3 is a schematic view, showing a drug miller, a first carrier and a second carrier of the preferred embodiment according to the present invention during a drug crushing;

FIG. 4 is a schematic view, showing a first carrier and a second carrier of a second preferred embodiment according to the present invention;

FIG. 5 is a schematic view, showing a first carrier and a second carrier of a third preferred embodiment according to the present invention;

FIG. 6 is a schematic view, showing a first carrier and a second carrier of a fourth preferred embodiment according to the present invention;

FIG. 7 is a perspective view, respectively showing a first carrier and a second carrier of a fifth preferred embodiment according to the present invention;

FIG. 8 is an exploded view, showing a first carrier and a second carrier of the fifth embodiment according to the present invention; and

FIG. 9 is a perspective view, showing a first carrier and a second carrier of the fifth embodiment according to the present invention while being coupled to each other.

### DETAILED DESCRIPTION OF THE PREFERRED EMBODIMENTS

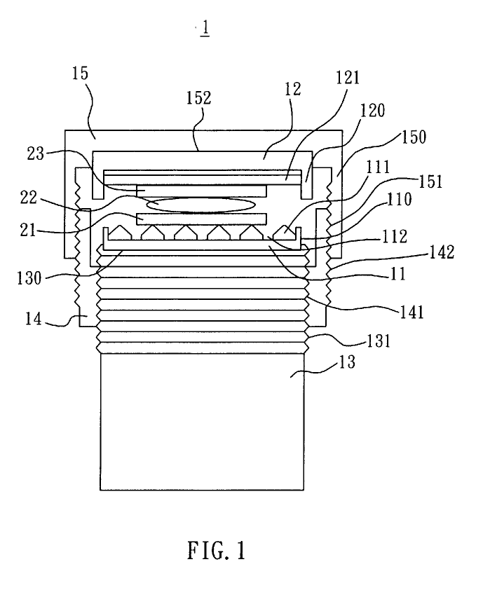

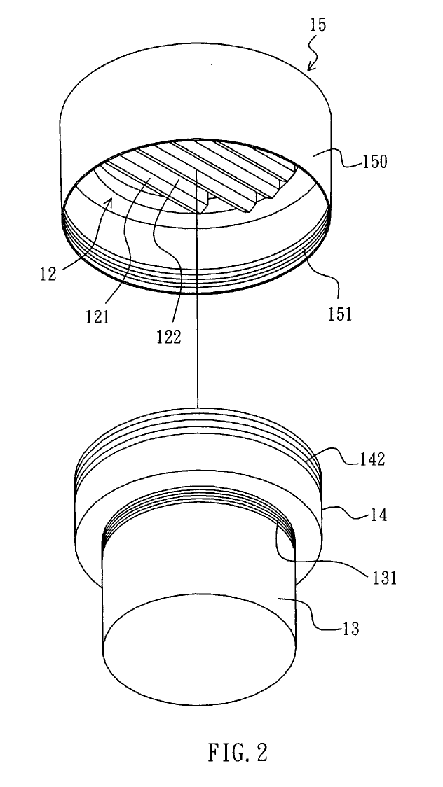

Referring to FIGS. 1, 2 and 3, a drug miller 1 of a first preferred embodiment according to the present invention includes an edible first carrier 11 and an edible second carrier 12, where the upper end face of the first carrier 11 and the lower end face of the second carrier 12 respectively have a first annular wall 110 and a second annular wall 120. Furthermore, first convex portions 111 and first concave portions 112 are disposed inside the first annular wall 110 as FIG. 1 shows, and second convex portions 121 and second concave portions 122 are disposed inside the second annular wall 120 as FIG. 2 shows; the first carrier 11 and the second carrier 12 respectively have the plurality of parallel arranged blade-shaped first convex portions 111 and second convex portions 121. The first concave portion 112 is disposed between each two adjacent first convex portions 111, and the second concave portion 122 is disposed between each two adjacent convex portions 121. Furthermore, the inner diameter of the second annular wall 120 is larger than the outer diameter of the first annular wall 110 such that the second annular wall 120 can be put around the outer side of the first annular wall 110.

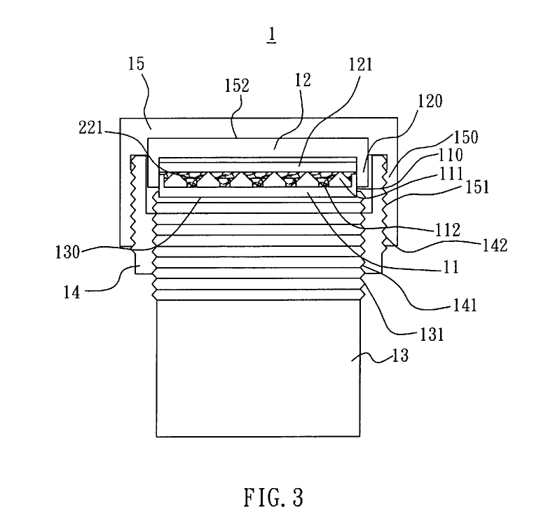

Referring to FIG. 1 again, an edible first adhesive layer 21, a drug 22 and an edible second adhesive layer 23 may stacked in sequence on the upper ends of the first convex portions 111 of the first carrier 11, and the lower ends of the second convex portions 121 of the second carrier 12 is then placed on the top end of the second adhesive layer 23. Thereafter, the drug 22 is pressed down, rotated and crushed into fragments 221, thereby allowing the fragments 221 of the drug 22 to be mixed with the first adhesive layer 21 and the second adhesive layer 23, and placed in the first concave potions 112 and the second concave portions 122. Furthermore, the second annular wall 120 is put around the first annular wall 110, allowing the first adhesive layer 21, the fragments 221 of the drug 22 and the second adhesive layer 23 to be accept inside the first carrier 11 and the second carrier 12 as FIG. 3 shows. Therefore, because the first and second carriers 11 and 12 block the odor of the drug 22, animals rather cannot smell it, they would eat the fragments 221 of the drug 22 together with the edible first and second carriers 11 and 12, thereby achieving the animal medication easily. The first adhesive layer 21 and the second adhesive layer 23 may respectively made of a material such as cheese, starch paste or the like, which may further be added with animal's favorite flavoring. In the drug miller 1 of the present invention. The first convex portions 111, second convex portions 121, first concave portions 112 and second concave portions 122 allow the fragments 221 of the drug 22 between the first carrier 11 and the second carrier 12, the first adhesive layer 21 and the second adhesive layer 23 to have more contact with the first carrier 11 and the second carrier 12, thereby increasing a combination area and strength thereof to distribute the fragments 221 of the drug 22 more broadly and uniformly between the first carrier 11 and the second carrier 12. When the first carrier 11 and the second carrier 12 are bit into pieces by an animal, the fragments 221 of the drug 22 may also be stuck to fragments of the first carrier 11 and the second carrier 12 and rather not separated from the fragments of the first carrier 11 and the second carrier 12.

Referring to FIGS. 1, 2 and 3 again, the drug miller 1 of the present invention may further include a base 13, a first motion element 14 and a second motion element 15. A first groove 130 for accepting and supporting the bottom of the first carrier 11 is disposed on the upper end face of the base 13, and first external threads 131 are disposed on the upper end of the base 13. The first motion element 14 is annular, and the inner side face thereof is disposed with first internal threads 141 and the outer side face thereof is disposed with second external threads 142. The first internal threads 141 are engaged with the first external threads 131, allowing the first motion element 14 to be coupled movably to the base 13. In addition, a third annular wall 150 is disposed on the lower end of the second motion element 15, and second internal threads 151 are disposed on the inner side face of the third annular wall 150. A second groove 152 for accepting the top end of the second carrier 12 is disposed inside the second motion element 15. The second internal threads 151 are engaged with the second external threads 142, allowing the second motion element 15 to be coupled movably to the first motion element 14.

The bottom of the first carrier 11 may be place in the first groove 130 at the upper end face of the base 13, thereby using the base 13 to support the first carrier 11. Thereafter, the first motion element 14 is used to engaged with the base 13, and a height of the top end of the first motion element 14 projected out of the first carrier 11 is then adjusted, where the height thereof is preferably equal to the height of the top end of the second carrier 12 after the second carrier 12 is engaged with the first carrier 11 as FIG. 3 shows, thereby controlling an amount of downward movement of the second motion element 15 to prevent the amount form being overlarge to press the second carrier 12 and the first carrier 11 excessively to cause the second carrier 12 and the first carrier 11 to be crushed.

The second motion element 15 is rotated to cause the second motion element 15 to exert a downward pressure on the second carrier 12, further to cause the second carrier 12 to exert a downward pressure on the second adhesive layer 23, the drug 22 and the first adhesive layer 21 to mix the drug 22 with the second adhesive layer 23 and the first adhesive layer 21 to form a mixture after being crushed into powder, where the mixture is placed in the first concave portions 112 and the second concave portions 122, thereby coupling the first carrier 11 to the second carrier 12 as FIG. 3 shows. Using the base 13, the first motion element 14 and the second motion element 15 is rather labor-saving when the first carrier 11 and the second carrier 12 are in the action of the drug milling, and the first carrier 11 and the second carrier 12 will rather not be crushed even if a user exerts an improper force.

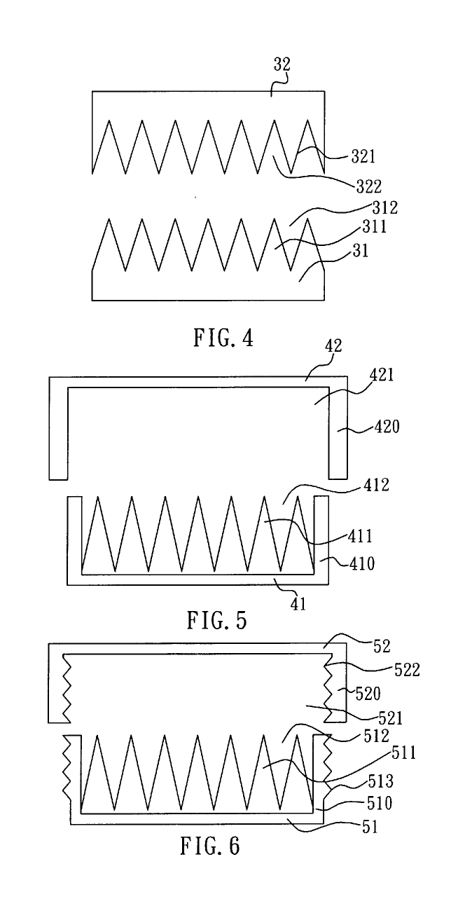

Referring to FIG. 4, a first carrier 31 of a second preferred embodiment according to the present invention has a plurality of convex portions 311 and a plurality of first convex portions 312, and a second carrier 32 has a plurality of second convex portions 321 corresponding to the plurality of first concave portions 312 and a plurality of second concave portions 322 corresponding the plurality of first convex portions 311. The first convex portions 311 can be placed in the second concave portions 322 and the second convex portions 321 can be placed in the first concave portions 311 when the first carrier 31 is coupled to the second carrier 32. The first carrier 31 and the second carrier 32 of the present embodiment can also grind drugs into fragments and encapsulate the drug fragments. In addition, the first carrier 31 and the second carrier 32 of the present embodiment may also grind the drug 22 into fragments, mix the fragments with the second adhesive layer 23 and the first adhesive layer 21 into a mixture, put the mixture in the first concave portions 312 and the second concave portions 322 and then couple the first carrier 31 to the second carrier 32 through the base 13, the first motion element 14 and the second motion element 15 shown in FIG. 1, thereby saving labor and rather not crushing the first carrier 31 and the second carrier 32 even if an improper force is exerted by a user during the milling.

Referring to FIG. 5, a first carrier 41 of a third preferred embodiment according to the present invention has a first annular 410, a plurality of first convex portions 411 and a plurality of first concave portions 412, where the first convex portions 411 and the first concave portions 412 are positioned inside the first annular wall 410. A second carrier 42 has a second annular wall 420 and a second concave portion 421, where the second annular wall 420 may be put around the outer side of the first annular wall 410, thereby coupling the first carrier 41 to the second carrier 42, and accepting the first annular wall 410 and the plurality of first convex portions 411 in the second concave portion 421. The first carrier 41 and the second carrier 42 may also grind drugs into fragments and capsulate the drug fragments. In addition, the first carrier 41 and the second carrier 42 of the present embodiment may also grind the drug 22 into fragments, mix the fragments with the second adhesive layer 23 and the first adhesive layer 21 into a mixture, put the mixture in the first concave portions 412 and the second concave portion 421 and then couple the first carrier 41 to the second carrier 42 through the base 13, the first motion element 14 and the second motion element 15 shown in FIG. 1, thereby saving labor and rather not crushing the first carrier 41 and the second carrier 42 even if an improper force is exerted by a user during the milling.

Referring to FIG. 6, a first carrier 51 of a fourth preferred embodiment according to the present invention has a first annular wall 510, a plurality of first convex portions 511 and a plurality of first concave portions 512, where the first convex portions 511 and the second concave portions 512 are positioned inside the first annular wall 510 and external threads 513 are disposed on the outer side face of the first annular wall 510. A second carrier 52 has a second annular wall 520 and a second concave portion 521, where third internal threads 522 corresponding to the third external threads 513 are disposed on the inner side face of the second annular wall 520. Thereupon, the third external threads 513 is engaged with the third internal threads 522, allowing the second annular wall 520 to be engaged with the first annular wall 510 and the first carrier 51 to be then engaged with the second carrier 52, thereby accepting the first annular wall 510 and the plurality of first convex portions 511 in the second concave portion 52. The first carrier 51 and the second carrier 52 of the present embodiment may also grind drugs into fragments and capsulate the drug fragments.

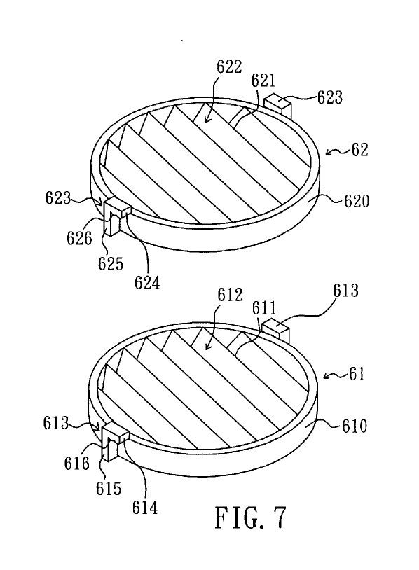

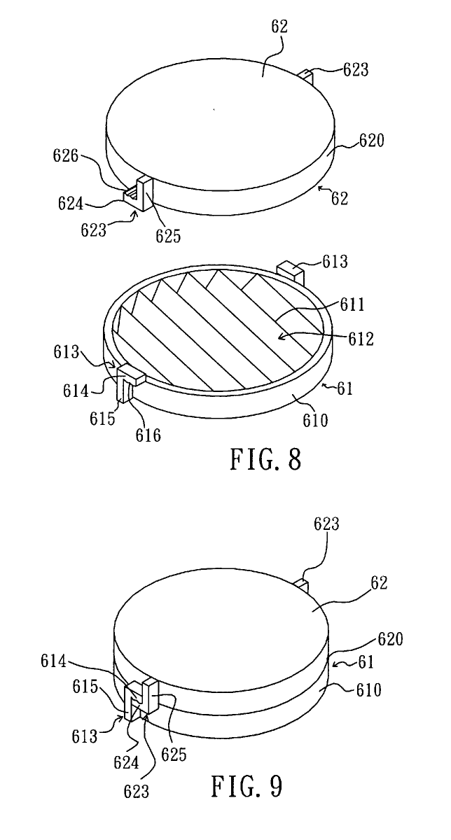

Please referring to FIGS. 7, 8 and 9, a first carrier 61 and a second carrier 62 of a fifth preferred embodiment respectively have a first annular wall 610 and a second annular wall 620, where first convex portions 611 and first concave portions 612 are disposed inside the first annular wall 610, and second convex portions 621 and second concave portions 622 are disposed inside the second annular wall 620 as FIG. 7 shows; the first carrier 61 and the second carrier 62 respectively have the plurality of parallel arranged blade-shaped first convex portions 611 and second convex portions 621. The first concave portion 612 is disposed between each tow adjacent first convex portions 611, and the second concave portion 622 is disposed between each two adjacent convex portions 621. Furthermore, the first annular wall 610 and the second annular wall 620 respectively have at least two first engagement units 613 and at least two second engagement units 623 corresponding to each other, where the first engagement unit 613 and the second engagement unit 623 are respectively projected out of the first annular wall 610 and the second annular wall 620.

Referring to FIG. 7 again, the first engagement unit 613 has a first engaging portion 614 and a first stopping portion 615, where the upper end of the first engaging portion 614 is higher than the upper end of the first annular wall 610, and the first engaging portion 614 is connected to the upper end of the first stopping portion 615. The second engagement unit 623 has a second engaging portion 624 and a second stopping portion 625, where the upper end of the second engaging portion 624 is higher than the upper end of the second annular wall 620, and the second engaging portion 624 is connected to the upper end of the second stopping portion 625. Furthermore, the first engaging portion 614 and the second engaging portion 624 respectively have a first tooth structure 616 and a second tooth structure 626 corresponding to each other, allowing the first engaging portion 614 and the second engaging portion 624 rather not to be separated from each other after being engaged with each other.

The first carrier 61 and the second carrier 62 may also grind drugs into fragments, and encapsulate the drug fragments. The second carrier 62 is rotated to cause the first tooth structure 616 to be propped against and buckled up the second tooth structure 626, and the first engaging portion 614 and the second engaging portion 624 are respectively propped against the second stopping portion 625 and the first stopping portion 615 after the first engaging portion 614 is aligned with the second engaging portion 624 corresponding thereto as FIG. 9 shows, thereby engaging the first engagement unit 613 with the second engagement unit 623 and then fixing the second carrier 62 tightly to the first carrier 61.

The first carrier 61 and the second carrier 62 of the present embodiment may also grind the drug 22 into fragments as FIG. 9 shows, mix the fragments with the second adhesive layer 23 and the first adhesive layer 21 into a mixture, put the mixture in the first concave portions 612 and the second concave portions 621, thereby saving labor and rather not crushing the first carrier 61 and the second carrier 62 even if an improper force is exerted by a user during the milling. Thereafter, the first carrier 61 and the second carrier 62 are taken out, and the second carrier 62 is then rotated to couple the first carrier 61 to the second carrier 62. The first carrier 61 and the second carrier 62 of the present embodiment may also have the same shape and structure, thereby saving the facilities cost needed for manufacturing the first carrier 61 and the second carrier 62.

The present invention uses the edible first and second carriers with a milling function to grind drugs into fragments, and may further uses the base, the first motion element and the second motion element to grind drugs into fragments more conveniently and rather not damaging the first carrier and the second carrier, encapsulate the drug fragments in the edible first and second carriers, allowing animals rather not to be able to smell the odors of the drugs from the outsides of the first carrier and the second carrier and to eat the drugs together with the edible first and second carriers. Therefore, the present invention can improve the deficits of conventional drug millers, and achieve the convenient animal medication.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A drug miller, comprising:
a first carrier, having at least one first convex portion and at least one first concave portion, and made of an edible material; and
a second carrier, having at least one second concave portion, and made of an edible material;
Wherein said first carrier and said second carrier are adapted to encapsulate a drug, thereby accepting drug fragments in said first concave portion and said second concave portion when said first convex portion is used to crush said drug into said drug fragments, allowing an animal rather not to smell odor of said drug from the outsides of said first carrier and said second carrier.

2. The drug miller according to claim 1, wherein said first carrier has a first annular wall; said first convex portion and said first concave portion are disposed inside said first annular wall; said second carrier has a second wall;
said second concave portion is disposed inside said second annular wall.

3. The drug miller according to claim 2, wherein said first carrier has a multiple number of said first convex portions arranged parallel to one another, said first convex is a blade-shaped object; said first concave portion is disposed between said two adjacent first convex portions.

4. The drug miller according to claim 3, wherein said second carrier has a plurality of parallel arranged second convex portions, said convex portion is a blade-shaped object;
said second concave portions is disposed between said two adjacent second convex portions; said second convex portions are disposed inside said second annular wall.

5. The drug miller according to claim 4. wherein an inner diameter of said second annular wall is larger than an outer diameter of said first annular wall, thereby coupling the first carrier to said second carrier when said second annular wall is put around said first annular wall.

6. The drug miller according to claim 4, wherein said first annular wall and said second annular wall respectively have at least two first engagement units and at least two second engagement units corresponding to each other, said first engagement unit and said second engagement unit are respectively projected out of said first annular wall and said second annular wall; said first carrier is coupled to said second carrier when said first engagement units are respectively engaged with said second engagement units corresponding thereto.

7. The drug miller according to claim 6, wherein said first engagement unit has a first engaging portion and a first stopping portion; an upper end of said first engaging portion is higher than an upper end of said first annular wall; said first engaging portion is connected to an upper end of said first stopping portion; and said second engagement unit has a second engaging portion and a second stopping portion; an upper end of said second engaging portion is higher than an upper end of said second annular wall; said second engaging portion is connected to an upper end of said second stopping portion; the first engaging portion is propped against and buckled up said second engaging portion, and said first engaging portion and said second engaging portion are respectively propped against said second stopping portion and said first stopping portion when said first engagement unit is engaged with said second engagement unit.

8. The drug miller according to claim 7, wherein said first engaging portion and said second engaging portion respectively have a first tooth structure and second tooth structure corresponding to each other.

9. The drug miller according to claim 2, wherein said first annular wall and said second wall respectively have at least two first engagement units and at least two second engagement units corresponding to each other, said first engagement unit and said second engagement unit are respectively projected out of said first annular wall and said second annular wall; said first carrier is coupled to said second carrier when said first engagement units are respectively engaged with said second engagement units corresponding thereto.

10. The drug miller according to claim 9, wherein said first engagement unit has a first engaging portion and a first stopping portion; an upper end of said first engaging portion is higher than an upper end of said first annular wall; said first engaging portion is connected to an upper end of said first stopping portion; and said second engagement unit has a second engaging portion and a second stopping portion; an upper end of said second engaging portion is higher than an upper end of said second annular wall; said second engaging portion is connected to an upper end of said second stopping portion; the first engaging portion is propped against and buckled up said second engaging portion, and said first engaging portion and said second engaging portion are respectively propped against said second stopping portion and said first stopping portion when said first engagement unit is engaged with said second engagement unit.

11. The drug miller according to claim 10, wherein said first engaging portion and said second engaging portion respectively have a first tooth structure and second tooth structure corresponding to each other.

12. The drug miller according to claim 1, wherein said second carrier has at least one second convex portion; said first concave portion corresponds to said second convex portion;
said first convex portion corresponds to said second concave portion, thereby placing said first convex in said second concave portion, and said second convex portion in said first concave portion when said first carrier is coupled to said second carrier.

13. The drug miller according to claim 1, wherein said first carrier has a first annular wall; said first convex portion and said first concave portion is disposed inside said first annular wall; said second carrier has a second annular wall; said second concave portion is disposed inside said second annular wall; external threads are disposed on an outer side face of said first annular wall;
internal threads corresponding to said external threads are disposed on an inner side face of said second annular wall, thereby engaging second annular wall with said first annular wall and then coupling said first carrier to said second carrier by engaging said external threads with said internal threads.

14. The drug miller according to claim 1, further comprising a base, a first motion element and a second motion element;
said first motion element is coupled movably to said base, and said second motion element is coupled movably to said first motion element; said base is adapted to support said first carrier, and said second motion element is adapted to press said second carrier.

15. The drug miller according to claim 14, wherein a first groove for accepting a bottom of said first carrier is disposed on an upper end face of said base; first external threads are disposed on an upper end of said base; said first motion element is an annular body, first internal threads are disposed on an inner side face of said first motion element, and second external threads are disposed on an outer side face of said first motion element; said first internal threads are engaged with said first external threads; a third annular wall is dispose on an lower end of said second motion element, and second internal threads are disposed on an inner side face of said second annular wall; a second groove for accepting an upper end of said second carrier is disposed inside said second motion element; said second internal threads are engaged with said second external threads.

16. The drug miller according to claim 8, further comprising a base, a first motion element and a second motion element;
said first motion element is coupled movably to said base, and said second motion element is coupled movably to said first motion element; said base is adapted to support said first carrier, and said second motion element is adapted to press said second carrier.

17. The drug miller according to claim 16, wherein a first groove for accepting a bottom of said first carrier is disposed on an upper end face of said base; first external threads are disposed on an upper end of said base; said first motion element is an annular body, first internal threads are disposed on an inner side face of said first motion element, and second external threads are disposed on an outer side face of said first motion element; said first internal threads are engaged with said first external threads; a third annular wall is dispose on an lower end of said second motion element, and second internal threads are disposed on an inner side face of said second annular wall; a second groove for accepting an upper end of said second carrier is disposed inside said second motion element; said second internal threads are engaged with said second external threads.

18. The drug miller according to claim 11, further comprising a base, a first motion element and a second motion element;
said first motion element is coupled movably to said base, and said second motion element is coupled movably to said first motion element; said base is adapted to support said first carrier, and said second motion element is adapted to press said second carrier.

19. The drug miller according to claim 18, wherein a first groove for accepting a bottom of said first carrier is disposed on an upper end face of said base; first external threads are disposed on an upper end of said base; said first motion element is an annular body, first internal threads are disposed on an inner side face of said first motion element, and second external threads are disposed on an outer side face of said first motion element; said first internal threads are engaged with said first external threads; a third annular wall is dispose on an lower end of said second motion element, and second internal threads are disposed on an inner side face of said second annular wall; a second groove for accepting an upper end of said second carrier is disposed inside said second motion element; said second internal threads are engaged with said second external threads.
